(19) United States
(12) Patent Application Publication
(10) Pub. No.: US 2017/0159270 A1
(43) Pub. Date: Jun. 8, 2017

(54) METHOD FOR MONITORING, COMMUNICATING AND CONTROLLING WATER CONSUMPTION AND AVAILABILITY AND SYSTEM THEREOF

(71) Applicant: NEOTECH SYSTEMS PVT. LTD., New Delhi (IN)

(72) Inventor: RAJESH GARG, FARIDABAD (IN)

(21) Appl. No.: 15/327,541

(22) PCT Filed: Jul. 10, 2015
(86) PCT No.: PCT/IB2015/055225

§ 371 Date: Jan. 19, 2017

(30) Foreign Application Priority Data
Jul. 21, 2014 (IN) 2055/DEL/2014

(51) Int. Cl. E03B 11/10; G06Q 30/06; G06F 17/22; G01F 25/00; E03B 11/12; E03B 11/14

(52) U.S. Cl. CPC E03B 11/10; E03B 11/12; E03B 11/14; G06F 17/2205; G01F 25/00; G06Q 30/0605

(57) ABSTRACT

The present invention related to a method for monitoring, communicating and controlling water consumption and availability and system thereof. More specifically, the present invention relates to a method for monitoring, communicating and controlling water consumption and availability at domestic stage or commercial stage and predicting and advising the future usage of water to users located at local sites or at remote site.

### FIELD OF INVENTION

The present invention relates to a method for monitoring, communicating and controlling water consumption and availability and system thereof. More specifically, the present invention relates to controlling and monitoring of liquids (especially water) levels, consumption and availability in homes or commercial sites, indoors or outdoors. The system of the present invention is capable of communicating the information or being controlled from remote locations. The system is user programmable for the type of actions that it can perform automatically to achieve the desired results. The system is capable of maintaining historical data, learning the behaviour of the site, run analytics and give predictions and advisory to the user.

### BACKGROUND OF THE INVENTION

According to the wiki page for water; some observers have estimated that by 2025 more than half of the world population will be facing water-based vulnerability. A report, issued in November 2009, suggests that by 2030, in some developing regions of the world, water demand will exceed supply by 50%.

It is also important to note that not only the scarcity of usable water is a threat but the abundance of unusable water is also a problem as it can create multiple problems.

With these facts in mind it was realized that we need a system that can efficiently monitor water be it in tanks, sewerages, drainages or elsewhere so that it can be efficiently managed to not only increase the availability of usable water but also to protect infrastructure and improve the efficiency of the related services.

### OBJECTIVES OF INVENTION

The main objective of the present invention is to overcome at least one of the above mentioned problems.

Another objective of the present invention is to minimize the wastage/consumption of water on domestic stage or commercial stage.

Yet another objective of the present invention is to monitor, manage and predict the availability and consumption of usable/unusable water at domestic stage or commercial stage.

Still another objective of the present invention is to provide a user-friendly monitoring system capable of communicating with the user located at remote site or local site, to transmit information regarding availability/consumption of the water.

### SUMMARY OF INVENTION

The present invention relates to a method for monitoring, communicating and controlling water and system thereof. Accordingly the present invention relates to a method for monitoring, communicating and controlling liquid's (like water etc.) consumption and availability at domestic stage or commercial stage and predicting & advising the future usage of water to users at sites or from remote locations, the said method comprising, receiving and storing water from the first set of main supply lines in one or more underground tanks (UGT) via first set of electronic pumps; transferring the stored water of step (a) to one or more overhead tanks (OHT) via second set of electronic pumps and supply lines, and collecting the same in OHTs; supplying the collected water of step (b) to one or more household vats of individual users vide third set of electronic pumps and supply lines; arranging at least one Electronic Control Unit (ECU) and operationally configuring with all UGT, OHT, first, second and third set of electronic pumps, sensors, actuators, meters and supply lines, and household vats of individual users at various predefined locations; monitoring critical parameters continuously by sensors and meters deployed in the supply lines (first, second and third set), located at inlet and outlet of electronic pumps (the first, second and third set) and sending output from the sensor to the ECU; monitoring critical parameters continuously by sensors located in OHTs, UGTs and household vats, and sending outputs from the sensor to the ECU; calculating and computing the information received in steps (e) & (f) at ECU by various set of rules or logics in the processing unit of ECU and communicating the same to users in respect of consumptions & availability of water, by display units connected with the ECU, whereby the availability of water and consumption of water is reflected by Audio mode, video mode and/or access by cloud based system and/or personal computer or mobiles or tablets; controlling, predicting and advising to users about the consumption of water, based upon various information stored and recorded at ECU; keeping the users informed about details online or off-line or quasi modes by view-ability mechanisms that are capable of being configured to work simultaneously or in any combination as required and/or desired by end user.

The present invention also relates to a user-friendly household water monitoring system comprising at least one underground tank (UGT) provided to receive and store liquid pumped through a first set of main supply lines from a source. At least one overhead tank (OHT) provided to receive and store liquid propelled from the underground tank (UGT). At least one household vat provided to receive and store liquid propelled from the overhead tank (OHT). First set of pumps configured to propel the liquid through the first set of main supply lines to the underground tank (UGT). Second set of pumps configured to propel the liquid from underground tank (UGT) to the overhead tank (OHT) through the main supply line. Third set of pump configured to propel the liquid from the overhead tank to plurality of household vat through a secondary supply line. Plurality of sensors being deployed in the underground tank (UGT), overhead tank (OHT), household vats and at inlet region/outlet region of the first set of pumps, second set of pumps and the third set of pumps; a means for connecting the sensors to an electronic control unit (ECU) for transmitting data between the sensors and the electronic control unit; whereby the ECU consists a microprocessor for receiving data from the sensors and computing the communicating data based on set of rules and logics. At least one display unit provided at the user's end for monitoring the data collected by the electronic control unit, whereby the display unit being connected to the electronic control unit through a local network or a cloud server.

### BRIEF DESCRIPTION OF FIGURES

Further aspects and advantages of the present invention will be readily understood from the following detailed description with reference to the accompanying figures. The figures together with a detailed description below, are incorporated in and form part of the specification, and serve to further illustrate the aspects and explain various principles and advantages, in accordance with the present invention wherein:

FIGS. 1 and 2 illustrates an example of a user friendly household water monitoring system according to an aspect of the present invention.

FIG. 3 illustrates an example of a method by which the user friendly household monitoring system is exercised according to an aspect of the present invention.

FIG. 4a-4c shows a graphical representation of the water consumption/availability on hourly/daily basis and pump status, according to an aspect of the present invention.

### DETAIL DESCRIPTION OF INVENTION

While the invention is susceptible to various modifications and alternative forms, specific embodiment thereof has been shown by way of example in the figures and will be described in detail below. It should be understood, however that it is not intended to limit the invention to the particular forms disclosed, but on the contrary, the invention is to cover all modifications, equivalents, and alternative falling within the spirit and the scope of the invention as defined by the appended claims.

Before describing the embodiments in detail it may be observed that the novelty and inventive step that are in accordance with the present invention resides in a system and method of monitoring and managing liquid; especially water, availability, consumption or level for domestic, public or industrial use. It is to be noted that a person skilled in the art can be motivated from the present invention and modify the various constructions of system, set up assembly, which are varying from project to project. However, such modification should be construed within the scope and spirit of the invention. Accordingly, the drawings are showing only those specific details that are pertinent to understanding the embodiments of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a system, setup, device that comprises a list of components does not include only those components but may include other components not expressly listed or inherent to such system, setup or device. In other words, one or more elements in a system or apparatus proceeded by “comprises . . . a” does not, without more constraints, preclude the existence of other elements or additional elements in the system or apparatus. The following paragraphs explain present invention wherein a method for monitoring, communicating and controlling water and system thereof. The invention in respect of the same may be deduced accordingly.

Accordingly the present invention relates to a method for monitoring, communicating and controlling water consumption and availability at domestic stage or commercial stage and predicting & advising the future usage of water to users at sites or from remote locations, the said method comprising the steps:
(a) receiving and storing water from the first set of main supply lines in one or more underground tanks (UGT) via first set of electronic pumps;
(b) transferring the stored water of step (a) to one or more overhead tanks (OHT) via second set of electronic pumps and supply lines, and collecting the same in OHT's;
(c) supplying the collected water of step (b) to one or more household vats of individual users vide third set of electronic pumps and supply lines;
(d) arranging at least one Electronic Control Unit (ECU) and operationally configuring with all UGT, OHT, first, second and third set of electronic pumps, sensors, actuators, meters and supply lines, and household vats of individual users at various predefined locations;
(e) monitoring critical parameters continuously by sensors and meters deployed in the supply lines (first, second and third set), located at inlet and outlet of electronic pumps (the first, second and third set) and sending output from the sensor to the ECU;
(f) monitoring critical parameters continuously by sensors located in OHT's UGTs and household vats, and sending outputs from the sensor to the ECU;
(g) calculating and computing the information received in steps (e) & (f) at ECU by various set of rules or logics in the processing unit of ECU and communicating the same to users in respect of consumptions & availability of water, by display units connected with the ECU, whereby the availability of water and consumption of water is reflected by Audio mode, video mode or GUI and/or access by cloud based system and/or personal computer or mobiles or tablets;
(h) controlling, predicting and advising to users about the consumption of water, based upon various information stored and recorded at ECU;
(i) keeping the users informed about details online or off-line or quasi modes by view-ability mechanisms that are capable of being configured to work simultaneously or in any combination as required and/or desired by end user.

A first aspect of present invention, wherein in step (d) the ECU is operationally configured with electronic pumps, supply lines and tanks, through wired/wireless discrete sensors or continuous sensors or in combination thereof.

Another aspect of present invention, wherein in step (e) the sensors deployed in tanks and inlet/outlet of electronic pumps, are selected from set of analog sensors, digital sensors, logic based virtual sensors, meters or in combination thereof.

Yet another aspect of the present invention, wherein in step (e) and (f) the critical parameters are water level, amount of water leakage, pump status, water flow rate and motor RPM.

Yet another aspect of present invention, wherein in step (e) and (f) the ECU receives the output from the sensors, through plurality of sensing lines, discrete sensor, continuous sensors or in combination thereof.

In one another aspect of the present invention, wherein in step (g) the ECU communicates the computed information to the user, related to errors, logs, alerts, availability/consumption of water, status of electronic pumps, and history of availability/consumption of water.

Another aspect of present invention, wherein in the step (h) the ECU has an in-built memory to store the data received from the sensors, meters, actuators, pumps on hourly, weekly, monthly or yearly basis.

Yet another aspect of the present invention, wherein in step (h) the ECU predicts the future availability/consumption of water and provide advice to the user regarding efficient consumption of water, based on the computed information and data stored in ECU in-built memory.

In yet another aspect of the present invention, wherein in step (g) and (h), the ECU controls the switching operation of electronic pumps (first, second and third set), based on the availability of the water at the inlet and outlet of the electronic pumps (first, second and third set).

Still another aspect of the present invention, wherein in step (g) and (h), the ECU controls the switching operation of electronic pumps (first, second and third set), based on the water level in the underground tanks, the overhead tanks and the household vats.

Yet another aspect of the present invention, wherein in step (g) and (h) the ECU controls the switching operation of electronic pumps (first, second and third set), based on the user created multiple pump control schedule.

In another aspect of the present invention, wherein in step (g)-(i) the user receives the computed data on the display unit such as a wired device or on a remotely located personal computer, a tablet and/or a mobile phone.

The present invention also relates to a user-friendly household water monitoring system comprising: at least one underground tank (UGT) to receive and store liquid pumped through a first set of main supply lines from a source; at least one overhead tank (OHT) to receive and store liquid propelled from the underground tank (UGT); at least one household vat to receive and store liquid propelled from the overhead tank (OHT); first set of pumps configured to propel the liquid through the first set of main supply lines to the underground tank (UGT); second set of pumps configured to propel the liquid from underground tank (UGT) to the overhead tank (OHT) through the main supply line; third set of pump configured to propel the liquid from the overhead tank to plurality of household vat through a secondary supply line; a plurality of sensors being deployed in the underground tank (UGT), overhead tank (OHT), household vats and at inlet region/outlet region of the first set of pumps, second set of pumps and the third set of pumps; a means for connecting the sensors to an electronic control unit (ECU) for transmitting data between the sensors and the electronic control unit; whereby the ECU consists a microprocessor for receiving data from the sensors and computing the communicating data based on set of rules and logics; at least one display unit provided at the user's end for monitoring the data collected by the electronic control unit, whereby the display unit being connected to the electronic control unit through a local network or a cloud server.

A first aspect of the present invention, wherein each underground tank (UGT) is separately connected to one or more overhead tank (OHT), through the main supply line.

Another aspect of the present invention, wherein each household vat is separately connected to the outlet of each overhead tank, through a channel.

Yet another aspect of the present invention, wherein the electronic pumps are provided with flow rate sensor, pressure sensor, deployed at inlet and outlet of the first pump.

Still another aspect of the present invention, wherein the means for connecting the sensors to the electronic control unit is wireless or discrete/continuous sensors.

Another aspect of the present invention, wherein the electronic control unit has an in-built memory to store the data collected from the sensors at predetermined interval of time.

Yet another aspect of the present invention, wherein the ECU predicts the future availability/consumption of water and provide advice to the user regarding efficient consumption of water, based on the computed information and data stored in ECU in-built memory.

Yet another aspect of the present invention, wherein the ECU controls the switching operation of electronic pumps (first, second and third set), based on the availability of the water at the inlet and outlet of the electronic pumps (first, second and third set).

Still another aspect of the present invention, wherein the ECU controls the switching operation of electronic pumps (first, second and third set), based on the water level in the underground tanks, the overhead tanks and the household vats.

Yet another aspect of the present invention, wherein the ECU controls the switching operation of electronic pumps (first, second and third set), based on the user created multiple pump control schedule.

Yet another aspect of the present invention, wherein the user receives the computed data on the display unit such as a wired device or on a remotely located personal computer, a tablet and/or a mobile phone.

Accordingly, present invention relates to a method for monitoring, communicating and controlling water consumption and availability at domestic stage or commercial stage and predicting and advising the future usage of water to users at sites or from remote locations, the said method comprising the following steps;

### Step 1:

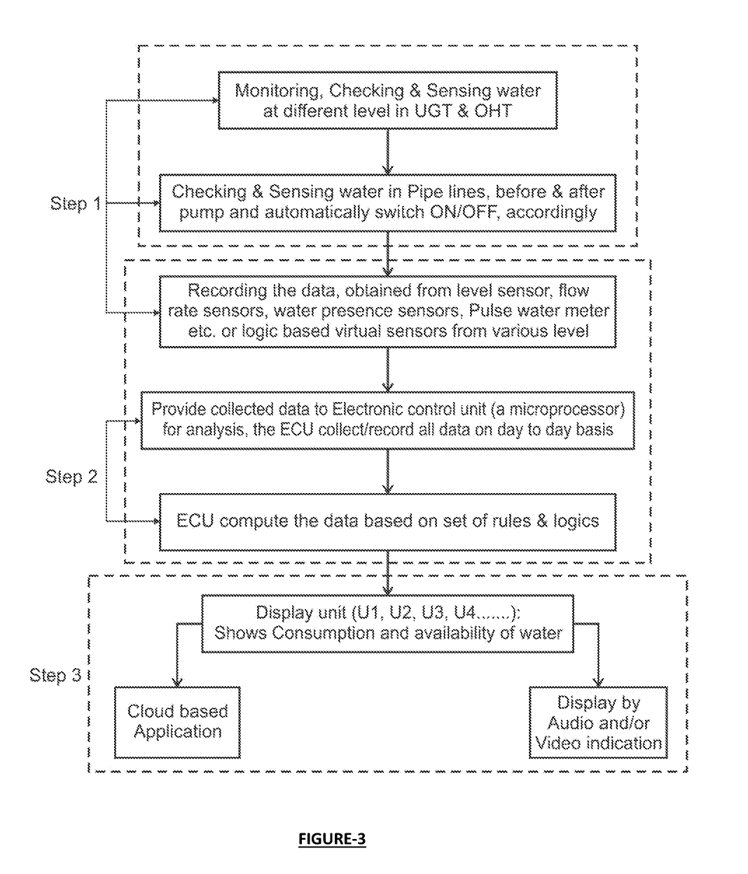

Step 1 (as shown in FIG. 3) includes monitoring of water level, flow rate, water availability and water leakage, at various locations such as overhead tanks, underground tanks, household tanks, main supply lines and channels via, sensors. The term “flow rate” herein defined as the volume of fluid which passes into (inflow) or exits (outflow) from a tank per unit time.

The said sensors facilitates in determining the availability of water at the various locations and also overall combined availability of water in the system. The sensors deployed in the present monitoring system monitors/senses the water flow rate, water level, pump RPM, water leakage and pulse water meter, but not limited to only these features. The sensors deployed at various locations are selected from set of meters, analog sensors, digital sensors, logic based virtual sensors or in combination thereof, for measuring/calculating/monitoring.

### Step 2

Step 2 (as shown in FIG. 3) includes transmitting collected data received from the sensors as mentioned in step 1, to the electronic control (ECU)/system/device unit via, sensing lines or wireless means. The electronic control unit (ECU) calculates and computes the received data from the sensors, by using various set of rules or logic, to acquire the data in respect of consumptions/availability of water on hourly, daily, weekly, monthly and yearly basis, but not limited to only these bifurcations. The term “consumption” herein defined as the total amount of water/fluid which passed through the outlet of a site (tank) over a given period. The term “availability” herein defined as the net amount of water/fluid available at a site at any given time. The electronic control unit creates automatic tasks on the basis of data received from the sensors. The automatic tasks includes detecting and preventing the overflow of water, managing flow of water between sites, programmed motor control, etc.

For example 1) if the flow of water is not detected by the sensors in the supply lines, then the electronic control unit (ECU) will switch OFF the electronic pump to avoid the dry run and eventually avoiding burnt-out of electronic pump. The term “dry run” herein defined as a state where a motor/pump is on but there is no water/fluid flowing between its inlet and outlet.

2). If the overhead tank is completely filled, then the electronic control unit (ECU) will switch OFF the electronic pump deployed to pump the water from the underground tank to overhead tank, to avoid the overflow of water.

3). In case the monitored site is a receiving drain of sewerage system, if it overflows then the concerned authority will be immediately notified.

Similar other user-programmable features are used for control and automation of tasks related to water/fluid. System is empowered to use other bifurcations of clock and calendar based calculation denominations as desired and required from application to application and by analytical methods. The ECU also calculates/predicts the future water usage on the basis of various factors such as, availability of water, history of water consumption, etc. The ECU is provided with an in-built memory to store data regarding availability/consumption of water, water pressure, pulse water meter, etc. for future use. The monitoring system is flexible enough to employ any number of discrete sensors or continuous sensors or actuators based on the requirement, for calculating various parameters.

Step 3

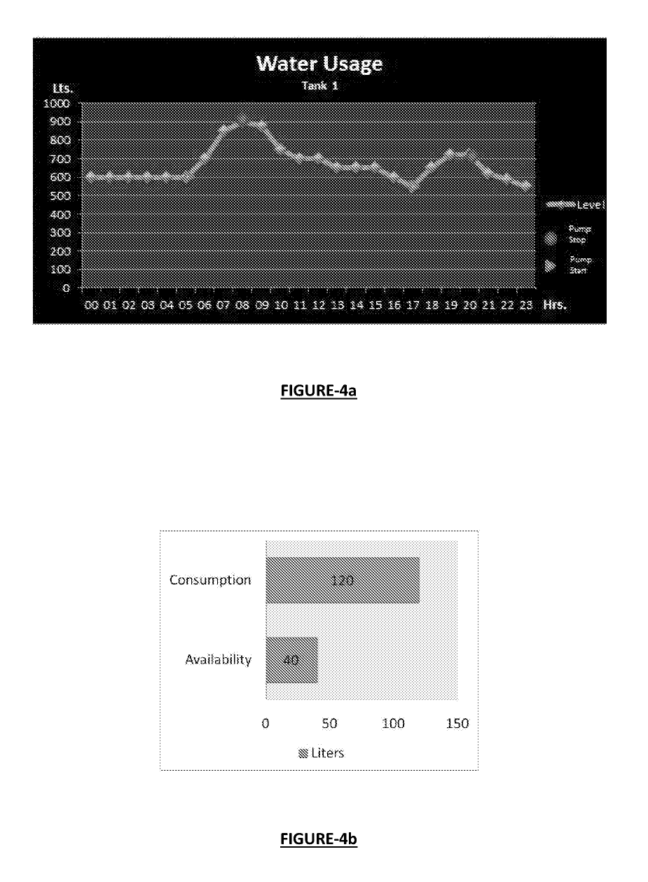

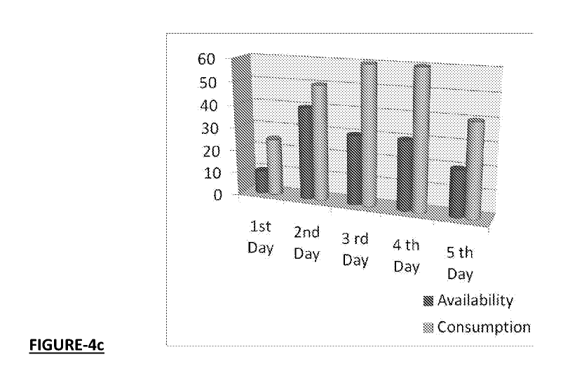

Step 3 (as shown in FIG. 3) includes communicating calculated/computed data received from the ECU as mentioned in step 2, to the users. The user receives the calculated data from the ECU, on the display units such as laptops, tablets, mobiles, smartphones, desktop computers etc. The electronic control unit send the data to the display unit via, Local Network or Radio Frequency Link. The information regarding consumption/availability of water, errors, logs, alerts, monitoring information, etc. are reflected by audio mode, visual mode and/or access by cloud based system and/or personal computer or mobile or tablets. The present system addresses the monitoring, view-ability through mobile/tablet/laptop GUI, audible methods and/or display panels to interact with the user. The ECU periodically sends the information to the user related to errors, logs, alerts, water availability/consumption, electronic pump running status, water usage history, prediction of future water usage etc (shown in FIGS. 4a, 4b and 4c). These multiple monitoring and view-ability mechanisms are empowered to work simultaneously or in any combination as required and/or desired by the user. Also the said monitoring and view-ability mechanisms can able to perform in online or off-line or quasi modes of connectivity to the system.

### Step 4

Step 4 includes sending feedbacks to the ECU from the user, on the basis of calculated/computed data received by the user as mentioned in step 2-3. The user generates a programmed schedule by using respective display units to control the operation of the electronic pumps. The said programmed schedule is transmitted to the electronic control unit which further controls the actuation of the electronic pumps, thereby controlling the flow of water between the tanks. The details prepared by the system about availability and consumption of water in terms of hourly, daily, weekly, monthly and yearly basis as mentioned in step 2 and 3 is further used to create the detailed analysis and patterns as per personalized usage and utilizes the same to improve and provide feedback and corrective parameters to the system and the users.

In another aspect of the present invention, the step 3 may also include transmission of data from the electronic control unit to the user, via cloud server/cloud system/cloud based connectivity. The cloud based connectivity and cloud system are also used to create the detailed analysis and patterns based on the personalized and group/community water usage/utilization, to improve the effectiveness and provide feedback/corrective parameters to the system for cloud based analytical engine users. This results in more corrective and improved accuracy of the availability and consumptions for those specific users. Moreover these analysis and patterns are used on collective basis to improve the systemic approaches towards controlling consumption of water. The cloud based monitoring system behaves like a control feedback and neural networks mixed with limited artificial intelligence also being used in limited parlance. The monitoring system may be setup with any number of discrete or continuous sensors and actuators as the solution being setup demands as the system is capable of being expanded by cascading as many Input/Output cards as desired. The different sensors can be wired or wireless.

Accordingly, the present invention also provides a user friendly household water monitoring system. Specifically, the present invention also relates to a user friendly household water monitoring system used for monitoring, communicating, controlling water consumption/availability of water at domestic stage or commercial stage and predicting/advising the future usage of water to users at sites or from remote locations.

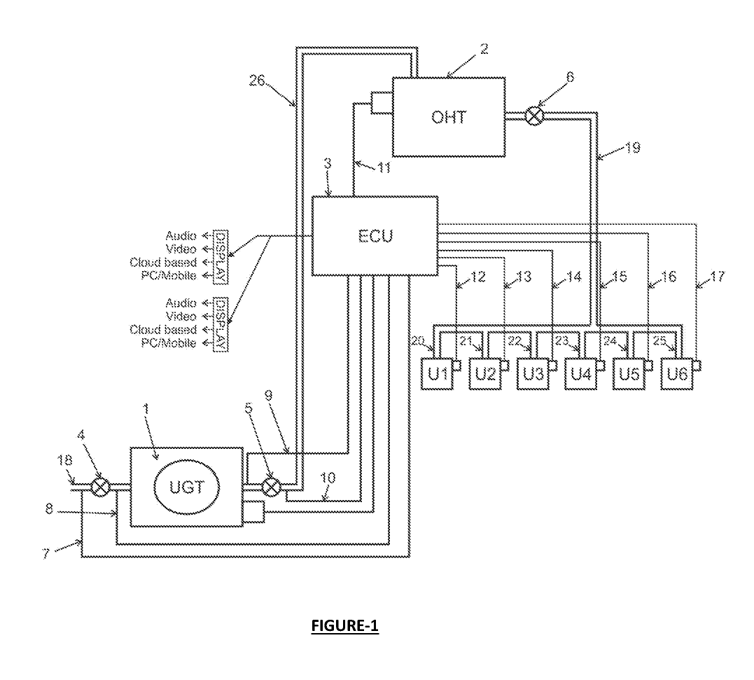

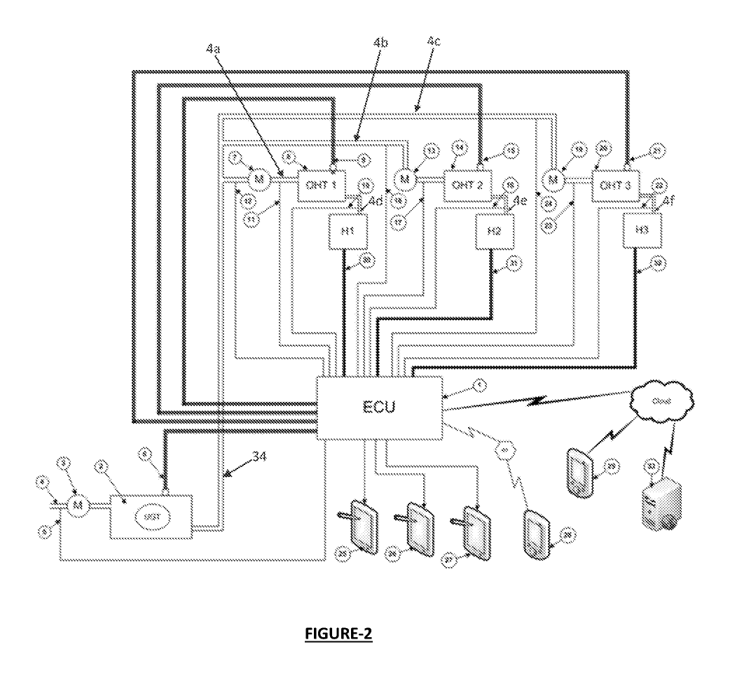

Referring to FIGS. 1 and 2, the user-friendly household water monitoring system comprising of a underground tank (UGT), overhead tank (OHT), household vat(s), main supply line, secondary supply line, first set of pumps, second set of pumps, third set of pumps, plurality of sensors, an electronic control unit (ECU), a means for connecting sensors and electronic control unit (ECU), display unit, local network and cloud server. It is important to note that the number of different system entities depicted in these examples are only for illustration and therefore can actually be more or less in a practical scenario since the system puts no limits on how many or none of a type are connected together.

The sensors deployed at various locations are selected from set of analog, digital, virtual logic based sensor or in combination thereof. The said various locations are UGT's, OHT's, household vats, main supply lines, channels and water meters, but not limited to only these location.

The Virtual level sensor is a perceived continuous water level measuring mechanism done without actually installing any sensors for it in a tank. Virtual sensors principally work based on the rate of inflow and outflow of water within a tank, machine learning and inputs like historical data, usage patterns etc. Virtual sensors minimize the discretization due to the limited number of real sensors that can be practically placed in a tank. This method determines the level of water between the real sensors.

For example the real sensors may be an indication of 0%, 10%, 20%, 30% . . . 100% but virtual sensors may indicate 0%, 1%, 2%, 3% . . . 100%. The extrapolation of historic data and pattern refine virtual sensors on periodic basis.

As shown in FIG. 1, the main supply line (18) is being provided to connect the underground tank (UGT) (1) and the source of water (not shown in FIG. 1). The source of water may be a river, lake, pond, sea, municipal tank, etc. The said main supply line (18) is provided with first set of pump (4) to propel water from the source to the underground tank (UGT) (1). The main supply line (26) is provided to connect the underground tank (UGT) (1) and the overhead tank (OHT) (2). The said main supply line (26) is provided with second set of pump (5) deployed between the UGT (1) and OHT (2), to propel water from underground tank (UGT) (1) to overhead tank (OHT) (2). The overhead tank is connected to the household vats, via a secondary main supply (19). The secondary supply line (19) is being divided in plurality of channels (20, 21, 22, 23, 24, 25), to connect each household vat with the overhead tank (OHT) (2). The secondary supply line (19) is being provided with third set of pump (6) to propel the water from the overhead tank (OHT) to each household vat through channels (20, 21, 22, 23, 24, 25). The sensors are deployed in the underground tank (UGT) (1), overhead tank (OHT) (2), household vats (U1, U2, U3, U4, U5, U6) and inlet region/outlet region of the each electronic pump. The electronic control unit (3) is being provided to receive the communicating data from the sensors, via sensing lines (8, 7, 9, 10, 11, 12, 13, 14, 15, 16, 17) and to process the communicating data based on the set of rules/logic. The data collected by the sensors is transmitted to the electronic control unit, via sensing lines or wired/wireless discrete and continuous sensors. The electronic control unit (ECU) (3) transmits the processed data to the user, via Local Network (not shown in FIG. 1) or cloud server (not shown in FIG. 1). The electronic control unit (3) has an in-build memory to store data collected from the sensor at predetermined interval of time. The electronic control unit (3) is being connected to the display unit (not shown in FIG. 1) at user's end, via local network.

In another aspect of the present invention as shown in FIG. 2, the electronic control unit comprising, plurality of overhead tanks (OHT's) connected to the underground tank via, main supply line (4). The main supply line (34) is being divided in plurality of channels (4a, 4b, 4c) to connect each overhead tank (8, 14, 20) with the underground tank (2).

As shown in FIG. 2, the main supply line (4) is being provided to connect the underground tank (UGT) (2) and the source of water. The source of water may be a river, lake, pond, sea, municipal tank, etc. The said main supply line (4) is provided with first set of pump (3) to propel water from the source to the underground tank (UGT) (2). The underground tank is connected to the overhead tank via, a main supply line (34). The main supply line (34) is being divided in plurality of channels (4a, 4b, 4c) to connect each overhead tank (8, 14, 20) with the underground tank (2). The said channels (4a, 4b, 4c) are provided with second set of electronic pumps (7, 13, 19) respectively, to propel water from underground tank (UGT) (2) to each overhead tanks (8, 14, 20). Each overhead tank (8, 14, 20) is individually connected to each household vat (H1, H2, H3), via channel (4d, 4e, 4f) respectively, example; the channel (4d) is provided to connect the overhead tank (8) and the household vat (H1). The sensors are deployed in the underground tank (UGT) (2), overhead tanks (OHT)(8, 14, 20), household vats (H1, H2, H3) and inlet region/outlet region of the each electronic pumps (3, 7, 13, 19). The electronic control unit (3) is being provided to receive the communicating data from the sensors, via sensing lines (5, 6, 9, 10, 11, 12, 15 16, 17, 18, 21, 22, 23, 24) and to process the communicating data based on the set of rules/logic. The electronic control unit transmits the processed data to the user via, Local network, Radio Frequency Link or a cloud server. The said sensors can be deployed at various locations in the main supply line (4) and channels (4a, 4b, 4c, 4d, 4e, 4f) to monitor various factors/parameters related to water flow rate, water level, water leakage etc. The sensors are being connected to the electronic control unit (1), via wired/wireless continuous sensor or wired/wireless discrete sensor. The electronic control unit (1) has an in-build memory to store data collected from the sensor at predetermined interval of time. The ECU (1) is being connected to the display units (25, 26, 27, 28, 29, 33) at user's end, via local network or cloud server.

In another aspect of the present invention, the electronic control unit comprising, plurality of overhead tanks (OHT's) connected to plurality of underground tank via, main supply line. Each underground tank is connected to the source of water by the main supply line. The main supply line is divided in plurality of channels to connect each underground tank with the source. Each channel is provided with a first set electronic pump to propel water from the source to each underground tank. Each underground tank is separately connected to each overhead tank, via channels. Each channel between underground tank and the overhead tank, provided with a second set of electronic pump to propel the water from the underground tank to overhead tank. Each overhead tank is separately connected to each household vat, via channel, wherein a third set of electronic pump is deployed to propel the water from each overhead tank to household vat.

In another aspect of the present invention each underground tank is separately connected to the source of the water via, main supply line.

The following examples are given bellow by way of illustration of the working of the invention in actual practice and therefore should not be constructed to limit the scope of the present invention.

### Example 1

The monitoring system is shown in FIG. 1 for illustration purpose, where the main supply line (17) supplies water from the source to the underground tank (UGT) (1) via first set of electronic pump (4). The electronic pump (4) supplies the water from the underground tank to overhead tank, when the water level in the underground tank is sufficient. Further, the second set of electronic pump (5) supplies the water from the underground tank (1) to the overhead tank (2). The third set of electronic pump (6) supplies the water from the overhead tank (2) to multiple household vats (U1, U2, U3, U4, U5 and U6) via channels (19, 20, 21, 22, 23, 24, 25) and so on.

As shown in FIG. 1, the electronic control unit (3) is operationally configured with UGT (1), OHT (2), main supply lines (18, 26) at various predefined locations and multiple household vats (U1, U2, U3, U4, U5, and U6). The ECU (3) receives data from the sensors deployed at main supply line (18, 26) located at inlet/outlet of the electronic pumps (4, 5, 6) via, sensing lines (6, 7, 8, 9). The ECU (3) unit remain in communication with OHT (2) via sensing line (10) for sending and receiving data related to water level in the OHT (2). A plurality of sensors are deployed at various location such as, main supply line (18, 26), inlet/outlet of electronic pumps (4, 5, 6), overhead tanks (2), underground tanks (1) and household vats (U1, U2, U3, U4, U5, and U6). The said sensors monitor/collect the data in respect of water level and water flow rate at various locations. The sensors transmit the collected data to the electronic control unit (3), thereby allowing the ECU (3) to use various automated tasks such as normal overflow, programmed water control/pump control, etc. The said automatic tasks comprises detecting and preventing the overflow of water, managing flow of water between sites, programmed pump control, etc. for example

1.) If the flow of water is not detected by the sensors in the supply line (18), then the electronic control unit (ECU) (3) will switch OFF the electronic pump (4) to avoid the dry run and eventually avoiding burnt-out of electronic pump (4).

2.) If the overhead tank (2) is completely filled, then the electronic pump (5) deployed to pump the water from the underground tank (1) to overhead tank (2) is switched OFF by the ECU (3) to avoid the overflow of water, and similar other features are used for control and automation of tasks related to water/fluid.

The electronic control unit triggers the second set electronic pumps (5), when the following conditions are satisfied:

1.) The water level in the overhead tanks (2) is below a pre-set level,

2.) The water level in the underground tank (1) is above the pre-set level.

3.) Flow of water is detected in the main supply lines.

The electronic control unit (1) will switch OFF the second set electronic pumps (5), when the following conditions are satisfied:

1.) The overhead tank (2) is completely filled,

2.) Flow of water is not detected in the supply lines,

3.) No leakage is detected in any of the supply lines. The term “pre-set level” herein refers to a water level set by the user or ECU that indicates the minimum amount of water available for propelling the same to another tank.

There are automated tasks in the system to automatically handle certain situations. It is possible to create multiple tasks as per the need of the user. Following are some of the examples of automated tasks performed by the electronic control unit

| S. No. | Automated Task |
|---|---|
| 1 | Turn OHT Pump On when water level in OHT goes |
| | below a pre-set level (By default 10%). |
| 2 | Turn OHT Pump Off when OHT is full. |
| 3 | Turn UGT Pump Off when UGT is full. |
| 4 | Turn OHT Pump Off if UGT is detected as Empty. |
| 5 | Turn OHT Pump On if UGT is full and OHT is |
| | below pre-set level (By default 70%). |
| 6 | Turn OHT Pump Off when UGT goes |
| | below a pre-set level (By default 10%). |
| 7 | Turn UGT pump on if UGT is not full and presence |
| | is detected in pipeline. |
| 8 | Turn UGT pump off if both tanks are full. |
| 9. | Turn the pump off for which dry-run is detected. |

The ECU (3) also remain in communication with household vats (U1, U2, U3, U4, U5, U6) via, sensing lines (12, 13, 14, 15, 16, 17) for sending and receiving data related to water level in each household vats. The electronic control unit (ECU) receives data from various sensors, via sensing lines (12, 13, 14, 15, 16, 17). The ECU calculates/computes the received data on the basis of various set of rules or logics, to acquire regarding consumptions/availability of water on hourly, daily, weekly, monthly and yearly basis, but not limited to only these bifurcations. The ECU is empowered to use other bifurcations of clock and calendar based calculation denominations as desired and required from application to application and by analytical methods.

Further there are display units connected with the ECU, whereby the availability of water and consumption of water is reflected by Audio mode, video mode and/or access by cloud based system and/or personal computer or mobiles or tablets. The present system addresses the monitoring, view-ability through GUI, audible methods and/or display panels to interact with the end user's regarding the various information related to errors, logs, alerts, monitoring information, calculation, inform about availability and consumption of water. Thus, keeps the users informed about such details in all 3-4 ways. These multiple monitoring and view-ability mechanisms are empowered to work simultaneously or in any combination as required and/or desired by end user. Also these monitoring and view-ability mechanisms are also needed to perform in online or off-line or quasi modes of connectivity to the system.

### Example 2

The monitoring system is shown in FIG. 2 for illustration purpose, where the Electronic Control Unit (ECU) (1) is operationally configured with the sensors, electronic pump and display units. The first set of electronic pump (3) propels the water through main supply line (4) to the underground tank (2). The electronic pumps (3, 7, 13, and 19) are controlled by the electronic control unit (ECU) (1), on the basis factors such as, water level in the respective tanks (2, 8, 14, 20), the flow rate of water in respective main supply line (4) etc. example

1.) If the flow of water is not detected by the sensors in the supply line (4), then the electronic control unit (ECU) (1) will switch OFF the electronic pump (3) to avoid the dry run and eventually avoiding burnt-out of electronic pump (3).

2.) If the overhead tank (8) is completely filled, then the electronic pump (7) deployed to pump the water from the underground tank (2) to overhead tank (8) is switched OFF by the ECU (1) to avoid the overflow of water, and similar other features are used for control and automation of tasks related to water/fluid.

The main supply line (4) supplies the water to UGT (2) from the source, via electronic pump (3). The sensors deployed in the underground tank (2) sends information to the ECU, regarding water level in the UGT to the ECU, via sensing line (6). The ECU (1) monitors the water level in underground tank (UGT) (2) and flow rate in main supply line (4), via sensors to keep a check on electronic pump (3) dry run. The sensors deployed in overhead tanks (OHT's) (8, 14, and 20) senses the water level in respective tanks and send the information regarding water level to the ECU via, sensing lines (9, 15, 21) respectively.

The electronic control unit triggers the respective second set electronic pumps (7, 13, and 19), when the following conditions are fulfilled:

1.) The water level in the respective overhead tanks (8, 14, and 20) is below a pre-set level,

2.) The water level in the underground tank is above the pre-set level.

3.) The flow of water is detected in the main supply lines.

The electronic control unit (1) will switch OFF the respective electronic pumps (7, 13, and 19), when the following conditions are fulfilled:

1.) The respective overhead tanks (8, 14 and 20) are completely filled,

2.) The flow of water is not detected in the supply lines,

3.) No leakage is detected in any of the supply lines.

The term “pre-set level” herein refers to a water level set by the user or ECU that indicates the minimum amount of water available for propelling the same to another tank.

The ECU also monitors the level of water in the OHT (8, 14, 20) via respective sensor line (9, 15, 21) and turns off the connected pump in case the tank is full or a dry run is detected example, if the overhead tank (14) is completely filled, then ECU will switch OFF the electronic pump (13) to avoid overflow of water. The data from the sensor lines (10, 11, 12), (16, 17, 18) and (22, 23, 24) helps the ECU (1) in keeping the track of the usage pattern for the different tanks (2, 8, 14, 20) and associated houses/tanks/household vats (H1, H2, H3). The data from the sensor/sensing lines (10, 11, 12, 16, 17, 18, 22, 23, 24) also helps the ECU (1) in detecting any leakage in the pipelines. The ECU (1) determines the extent of leakage and informs the user. The Distribution sensing lines (30, 31, and 32) provide the water distribution data to the ECU (1). The distribution data consists of the amount of water consumed in a particular activity (washing, bathing etc.) or via a certain outlet (taps, faucets, flushes etc.) or in a particular location (kitchen, bathroom etc.) of a house/households/household vats (H1, H2, H3). The distribution data is collected through the sensing lines (30, 31, and 32) or by the means of other wired or wireless discrete and continuous sensors. The discrete sensor generates a range of value which increases in fixed steps. The continuous sensors generate a signal that can assume any possible value in a given range.

The monitoring system of the present invention can accommodate any type of discrete sensors such as, sensors with two discrete outputs or sensors with more than two discrete outputs.

Distribution sensing facilitates advanced features like the water usage history, water usage pattern, water usage analysis, future water usage predictions, leak-detection etc. (not limited to only these features). The display unit (25, 26, 27, and 28) and control units are connected to the ECU via, Local Network or cloud server. The display unit provide data to the user regarding the water level, water availability/consumption, pump running status, leakage status, water usage history, advisory and future water uses prediction (shown in FIGS. 4a, 4b and 4c) (not limited to only these data). The display unit and control unit also facilitate the remote controlling of the electronic pumps. The connected display units and control units can be wired devices (25, 26, 27) or wireless devices (28, 29) like Mobile phones, tablets, etc. connected to the system through a local network over any standard or proprietary bus and protocol or over Wi-Fi, ZigBee, or any other RF interface. The display units (25, 26, 27, 28) and control units can also connect with the ECU through the cloud and cloud server when it is outside the local network. The cloud based web server (33) located at a remote data centre is capable of receiving and storing the data from different ECU (1). The mobile devices (28, 29) can also access the data from the web server through the cloud/internet.

The present system first addresses the monitoring, view-ability through GUI, audible methods and/or display panels about the consumptions/availability of water at the current time. System then prepares details about availability and consumption in terms of hourly, daily, weekly, monthly and yearly basis. This is further used to create the detailed analysis and patterns as per the personalized usage and utilize the same to improve and provide feedback and corrective parameters to the system. This results in more corrective and improved accuracy of the availability and consumptions for those specific users. The system of present invention is flexible enough to accommodating any type of sensors such as analog sensor, digital sensor, discrete sensor, continuous sensor, and virtual logic based sensors or in combination thereof. The monitoring system is capable of creating multiple user or system generated tasks to control various parameters of the system, on the basis of feedbacks and output from the electronic control unit and the sensors.

The above-said examples are merely for illustration purpose of the present invention. However, it is within the purview of the person skilled in the art that to increase the number of UGT, OHT, ECU units, and their interconnections with multiple tanks and display units. It is to be noted that a person skilled in the art can be motivated from the present example and modify the various modifications in the system, set up assembly, which are varying from project to project or domestic stage to commercial stage. However, such modification should be construed within the scope and spirit of the invention. Accordingly, the drawings are showing only those specific details that are pertinent to understanding the embodiments of the present invention so as not to obscure the disclosure with details that will be readily apparent to those of ordinary skill in the art having benefit of the description herein.

### Advantages and Applications of the Invention

In comparison to the existing products in the market, the solution being present has following improvements and extra functionalities with no significant implications over the cost of the product;

1. Maximize Availability of Water

The present system provides multiple monitoring points for sensing the level and availability of water by means of multiple real as well as virtual level sensors. It also has multiple programmable trigger points for controlling the water pumps. These close monitors and triggers automatically transfer the water from one site (say a UGT) to another site (say an OHT) to ensure that the UGT can accommodate the available supply water in case it is full. This feature eliminates the condition where there is little water in OHT and UGT which is full cannot accept more water even though it is available.

2. Eliminate Non-availability of Water

When the system senses that the overall (say UGT+OHT) level of water has fallen below a pre-set level; say 30%; then the system switches over to a critical state. In critical state the system ensures that the user is well informed about the current overall availability of water.

3. Minimize Wastage of Water

The system minimizes or rather eliminates the wastage of water due to overflow of water. It also presents to the user his water consumption patterns and quantified details along with the advisory to minimize the wastage of water.

It promotes judicious consumption of water, thereby bringing down the water and electricity bills and helping in water conservation. The inventors have been working to develop the invention, so that advantage can be achieved in an economical, practical, and facile manner. While preferred aspects and example configurations have been shown and described, it is to be understood that various further modifications and additional configurations will be apparent to those skilled in the art. It is intended that the specific embodiments and configurations herein disclosed are illustrative of the preferred nature of the invention, and should not be interpreted as limitations on the scope of the invention.

4. Monitor Unmanned Sites

The system can also be deployed to monitor the sites which cannot be practically monitored by the workforces, like the manholes, receiving drains, storm overflows, pumping stations etc. for sewerage or a drainage system. The system can be configured to notify the concerned authorities whenever a particular site needs their immediate attention. This can drastically reduce the cost of maintenance due to the damages caused by clogging or overflow at these sites.

In addition, the present invention provide following advantages:
The system has provision to hook up as many real level sensors as needed, by means of cascading multiple I/O cards, wired or wirelessly.
Wherever the real level sensors do not seem to be enough; there is a provision in the system to enable as many virtual level sensors as the user wants in the system. In contrast to the real sensors the virtual level sensors are software based level sensors based on a highly specialized algorithm to track the level of water in real time.
High number of level sensors in the system minimizes the granularity of the measurement and makes the readings nearly continuous and more precise.
Present system provides not only the level information but also the availability and the consumption data for a given period.
The availability and consumption information can be viewed either separately per tank or as an overall combined value.
The system presents the information not only through LEDs, LCDs and audible methods but also through a mobile phone/tablet based applications.
Besides the status of water at the site or in the tanks user can also program any associated pumps to turn on/off at set time periods; i.e. the user can create multiple pump control schedules.
There is also a provision to restrict the pump from getting turned on/off at the set time periods.
The system has an in-built memory to store the hourly history data of the water tanks.
The history data in the memory of the system can also be stored on the cloud so that there is no limit on the amount of data stored and it is accessible anytime anywhere.
The history data can also be analysed to create a water usage advisory for the user to further bring down his water footprint.
Cloud based application and connectivity of the monitoring system provides an extended functioning of this system.
The system also gives user the functionality to control various parameters and settings for the device and desires of the users through the GUI application.
The system also has various settings, connectivity and calibration related tasks in order to make it work as per the need and use of the user who will eventually use this and take all information display and configuration to work for his/her ultimate benefits and desires.
The system is flexible enough for monitoring variety of fluid/liquids at various monitoring sites such as sewage monitoring, drain monitoring etc.

1. A method for monitoring, communicating and controlling water consumption and availability at domestic stage or commercial stage and predicting & advising the future usage of water to one or more users, at the same time or at any moment in time, at sites or from remote locations, the method comprising the steps:
(a) receiving and storing water from the first set of main supply lines in one or more underground tanks (UGT) via a first set of electronic pumps;
(b) transferring the stored water of step (a) to one or more overhead tanks (OHT) via a second set of electronic pumps and supply lines, and collecting the same in OHTs,
(c) supplying the collected water of step (b) to one or more household vats of individual users via a third set of electronic pumps and supply lines;
(d) arranging at least one Electronic Control Unit (ECU) and operationally configuring with all of the UGTs, OHTs, first, second and third sets of electronic pumps, sensors, actuators, meters and supply lines, and household vats of individual users at various predefined locations;
(e) monitoring critical parameters continuously by sensors and meters deployed in the first, second and third sets of supply lines, located at an inlet and an outlet of the first, second and third sets of electronic pumps and sending an output from the sensor to the ECU;
(f) monitoring critical parameters continuously by sensors located in OHTs, UGTs and household vats, and sending outputs from the sensors to the ECU;
(g) calculating and computing the information received in steps (e) & (f) at the ECU by various sets of rules or logics in the processing unit of the ECU and communicating the same to the users in respect of consumptions & availability of water, by display units connected with the ECU, whereby the availability of water and consumption of water is reflected by Audio mode, video mode or GUI or access by a cloud based system, personal computer, mobiles or tablets;
(h) controlling, predicting and advising the users about the consumption of water, based upon various information stored and recorded at ECU; and
keeping the users informed about details online or off-line or quasi modes by view-ability mechanisms that are capable of being configured to work simultaneously or in any combination as required or desired by the end users.

2. The method as claimed in claim 1, wherein in step (d), the ECU is operationally configured with electronic pumps, supply lines and tanks, through wired/wireless discrete sensor, continuous sensors or combinations thereof.

3. The method as claimed in claim 1, wherein in step (e), the sensors deployed in tanks and inlet/outlet of electronic pumps, are selected from a set of analog sensors, digital sensors, logic based virtual sensors, meters or combinations thereof.

4. The method as claimed in claim 1, wherein in steps (e) and (f), the critical parameters are water level, amount of water leakage, pump status, water flow rate and motor RPM.

5. The method as claimed in claim 1, wherein in steps (e) and (f), the ECU receives the output from the sensors, through a plurality of sensing lines, discrete sensors, continuous sensors or combinations thereof.

6. The method as claimed in claim 1, wherein in step (g), the ECU communicates the computed information to the user, related to errors, logs, alerts, availability/consumption of water, status of electronic pumps, and history of availability/consumption of water.

7. The method as claimed in claim 1, wherein in step (h), the ECU has an in-built memory to store the data received from the sensors, meters, actuators, and pumps on an hourly, weekly, monthly or yearly basis.

8. The method as claimed in claim 1, wherein in step (h), the ECU predicts the future availability/consumption of water and provides advice to the user regarding efficient consumption of water, based on the computed information and data stored in an in-built memory of the ECU.

9. The method as claimed in claim 1, wherein in steps (g) and (h), the ECU controls the switching operation of the first, second, and third sets of electronic pumps, based on the availability of the water at the inlet and outlet of the first second and third sets of electronic pumps.

10. The method as claimed in claim 1, wherein in steps (g) and (h), the ECU controls the switching operation of the first, second and third sets of electronic pumps, based on the water level in the underground tanks, the overhead tanks and the household vats.

11. The method as claimed in claim 1, wherein in steps (g) and (h), the ECU controls the switching operation of the first, second and third sets of electronic pumps, based on the user created multiple pump control schedule.

12. The method as claimed in claim 1, wherein in steps (g)-(i), the user receives the computed data on the display unit such as a wired device or on a remotely located personal computer, a tablet or a mobile phone.

13. A user-friendly household water monitoring system comprising:
at least one underground tank (UGT) to receive and store liquid pumped through a first set of main supply lines from a source;
at least one overhead tank (OHT) to receive and store liquid propelled from the underground tank (UGT);
at least one household vat to receive and store liquid propelled from the overhead tank (OHT);
a first set of pumps configured to propel the liquid through the first set of main supply lines to the underground tank (UGT), a second set of pumps configured to propel the liquid from underground tank (UGT) to the overhead tank (OHT) through the main supply line, and a third set of pumps configured to propel the liquid from the overhead tank to a plurality of household vats through a secondary supply line;
a plurality of sensors deployed in the underground tank (UGT), the overhead tank (OHT), the household vats and at an inlet region/outlet region of the first set of pumps, the second set of pumps and the third set of pumps;
a means for connecting the sensors to an electronic control unit (ECU) for transmitting data between the sensors and the electronic control unit, whereby the ECU includes a microprocessor for receiving data from the sensors and computing the communicating data based on a set of rules and logics; and
at least one display unit provided at the user's end for monitoring the data collected by the electronic control unit, whereby the display unit is connected to the electronic control unit through a local network or a cloud server.

14. The monitoring system as claimed in claim 1, wherein each underground tank (UGT) is separately connected to the one or more overhead tank tanks (OHT), through the main supply line.

15. The monitoring method as claimed in claim 1, wherein each household vat is separately connected to the outlet of each overhead tank, through a channel.

16. The monitoring method as claimed in claim 1, wherein the electronic pumps are provided with a flow rate sensor and a pressure sensor, deployed at the inlet and the outlet of the first pump.

17. The monitoring method as claimed in claim 1, wherein the means for connecting the sensors to the electronic control unit is wireless or discrete/continuous sensors.

18. The monitoring method as claimed in claim 1, wherein the electronic control unit has an in-built memory to store the data collected from the sensors at a predetermined interval of time.

19. The monitoring method as claimed in claim 18, wherein the ECU predicts the future availability/consumption of water and provides advice to the user regarding efficient consumption of water, based on the computed information and data stored in the in-built memory of the ECU.

20. The monitoring method as claimed in claim 1, wherein the ECU controls the switching operation of the first, second and third sets of electronic pumps, based on the availability of the water at the inlet and outlet of the first, second and third sets electronic pumps.

21. The monitoring method as claimed in claim 1, wherein the ECU controls the switching operation of the first, second, and third sets of electronic pumps, based on the water level in the underground tanks, the overhead tanks and the household vats.

22. The monitoring method as claimed in claim 1, wherein the ECU controls the switching operation of the first, second and third sets of electronic pumps, based on the user created multiple pump control schedule.

23. The monitoring method as claimed in claim 1, wherein the user receives the computed data on the display unit such as a wired device or on a remotely located personal computer, a tablet or a mobile phone.
